(19) United States
(12) Patent Application Publication
(10) Pub. No.: US 2015/0153156 A1
(43) Pub. Date: Jun. 4, 2015

(54) HIGH SPATIAL AND SPECTRAL RESOLUTION SNAPSHOT IMAGING SPECTROMETERS USING OBLIQUE DISPERSION

(71) Applicant: Manhar L. Shah, Melbourne Beach, FL (US)

(72) Inventor: Manhar L. Shah, Melbourne Beach, FL (US)

(73) Assignee: MVM ELECTRONICS, INC., MELBOURNE, FL (US)

(21) Appl. No.: 14/552,137

(22) Filed: Nov. 24, 2014

Related U.S. Application Data
(60) Provisional application No. 61/911,108, filed on Dec. 3, 2013.

(51) Int. Cl. G01B 9/02; G01J 3/28; G01J 3/02

(52) U.S. Cl. CPC G01B 9/02044; G01J 3/0208; G01J 3/2823

(57) ABSTRACT

Snapshot imaging spectrometer systems, including snapshot hyperspectral imaging and snapshot spectral domain coherence tomography systems, with a large numbers of spectral channels and spatial pixels are desirable for applications ranging from detection of pollution and chemicals, environmental studies, surveillance, resources management, astronomy, biomedical and military use. Methods for achieving such high spatial and spectral resolutions and systems based upon these methods are disclosed. Significant increase in number of spectral channels, as compared to prior art systems, is possible with spread of spectral signature of pixels in oblique direction that allows longer than several times row (or column) spacing of a single wavelength pixel array at the final image. Methods and embodiments are disclosed that would advance the capabilities of prior art snapshot imaging spectrometer systems. In addition to a large number of spectral channels that may approach square of the optical compression factor of the lenslet or pinhole array, the oblique dispersion also stream lines the design and critical requirements of optical and mechanical components of comparable prior art systems due to better spatial form factor.

### RELATED APPLICATIONS

This application claims priority to U.S. Provisional Application No. 61/911,108 filed on Dec. 3, 2013.

### BACKGROUND

A high resolution image containing spatial and spectral information (wavelength and intensity of the radiation) is known as data cube. Data cube has become a powerful tool in almost every science and technology field. If a data cube is generated in time sequence as in scanning spectrometer, besides being at disadvantage for having mechanically moving parts or moving platform with respect to object, the exposure is reduced and different frame at different time may not provide true information. Snapshot type Imaging Spectrometer (SIS) systems that include Snapshot Hyperspectral Imaging (SHI) systems and Snapshot Spectral Domain Optical Coherence Tomography (SSD-OCT) systems, as an example, are proving advantageous over scanning and Fourier domain type. A large volume of literature is available on this topic and many references are listed in recent U.S. Pat. No. 8,233,148 to Bodkin et al. and U.S. Pat. No. 8,174,694 to Bodkin for SHI systems and US Patent Application Number 2013/0250290 to Tkaczyk et al. for SSD-OCT systems. These documents provide description of SHI and SSD-OTC systems and their importance and applications of data cube as well as many other references.

SHI systems disclosed by Bodkin in U.S. Pat. No. 8,174,694 utilize a cylindrical lens array and/or slit array near the image from front camera. This way, each image pixel row (column) gets compressed and nearly illumination free spaces between rows (columns) are generated. After pixels are dispersed with dispersing element and reimaged on focal plane array, rows (column) fill in blank spaces according to rows (column) spectral content. In this arrangement the number of spaces available to fill blank spaces between rows (columns) is to equal or less than optical compression factor of the cylindrical lens and/or slit array. That determines the number of spectral channels possible according to Bodkin's patent. Variations of the basic scheme are discussed in Bodkin's patent to have cylindrical lens array and/or slit array at position near detector array. Bodkin also provides different means by which dispersion and formation of image bars can be accomplished. All these approaches are generally applicable for arrangements and fabrication of similar other SIS systems besides SHI systems.

Since, Bodkin in U.S. Pat. No. 8,174,694 uses cylindrical lens array and/or slit array, image pixels have very large aspect ratio and require detectors in Focal Plane Array (FPA) of similar geometry. Alternatively, one can use an additional cylindrical lens to bring pixel's aspect ratio near 1:1 and select detector array with nearly square or round detector geometry, or use higher spatial resolution in that direction. However, the FPA aspect ratio would be large in that case.

Tkaczyk et al. disclose use of an image mapper with dispersive reimager to achieve snapshot operation of spectral domain optical coherence tomography systems. According to their discloser, interfering Electro Magnetic Radiation (EMR) image pixels received from front optics are divided and reflected in groups by an image mapper (multi-faceted mirror) in various distinct directions creating nearly illumination free spaces between redirected adjacent groups when dispersion is absent. After spectral dispersion and re-imaging, dispersed image pixels fall on distinct detector of the FPA.

In Tkaczyk et al.'s case of SSD-OCT system, the image at the image mapper is formed by the preceding optics from depth encoded interfering EMR produced either as emitted, back-scattered, reflected or scattered. In Bodkin's case, the image is formed at or near the cylindrical lens array and/or slit array by the preceding optics simply from incident EMR either emitted, back-scattered, reflected or scattered from an object. As for the SIS systems the EMR at the input from either system appears similar in nature; hence, the EMR input would mean same as image formed by the input optics at the image plane or position and may be referenced as input. The process from this input to FPA is same in both cases for SIS. The image mapper or cylindrical lens array and/or slit array can work in either case with number of spectral channels equal to their specific design. Elaborating further, the image mapper in an SSD-OCT system as disclosed by Tkaczyk et al. if is replaced with a cylindrical lens array and/or slit array in SHI system as disclosed by Bodkin in U.S. Pat. No. 8,174,694 or vice versa, basic functions of both those systems would be same. Addition of a multi-faceted mirror and accompanying complexity makes SSD-OCT system as disclosed by Tkaczyk et al. is more expensive and difficult to realize.

Bodkin et al. in U.S. Pat. No. 8,233,148 disclose use of lenslet and/or aperture array in place of cylindrical lens and/or slit array that were disclosed in U.S. Pat. No. 8,174,694. Bodkin et al. mention rotating the dispersing direction (i.e., angle of dispersive element relative to focal plane) to avoid overlap of different spectra on detector. However, they fail to teach how an oblique dispersion can be used to spread spectrum over nearly N times the number of rows (or columns) to achieve˜N×N spectral channels and closer to square optical, mechanical and photo-detector form factor, where N is the compression factor of the image pixel by lenslet and/or pinhole array. From the mechanical and optical design consideration it is advantageous to have dimension of image and pixels in both the directions (X and Y) approximately equal. My invention clearly shows how to achieve this result.

A larger number of spectral channels are desirable for accurate analyses in many instances, such as predicting chemical compositions, burn signatures, forensic, biomedical and genetics. Consider visible spectrum from 450 nm to 700 nm that is a range of 250 nm. Spectral resolution of 5 nm and sometimes even 1 nm is desirable. A SHI system with pixel compression of 6, and Bodkin et al.'s illustration for spectral spread would produce roughly 12 spectral channels. Roughly 36 spectral channels are possible with my invention disclosed here.

Data cube generated from SIS systems has three dimensional (3D) aspects. Mathematically, it is a 3D matrix with matrix element value corresponding to the radiation intensity. Two spatial dimensions and wavelength dimension constitute three dimensions of the data cube. In all SIS systems, image pixels are dispersed such that each dispersed pixel within a spectral band or channel nearly fill one detector of the detector array. Digital signal processing allows us to re-format the data so that a desired scene, such as a two dimensional (2D) color image where colors correspond to wavelengths in case of SHI systems, or a three dimensional (3D) object with depths decoded from wavelengths in case of SSD-OCT systems may be displayed. As long as dispersed pixel formation on the detector array is known, re-formatting can be done for any pattern. In U.S. Pat. No. 8,174,694 each pixel line is dispersed along row (column) direction. The possible number of spectral channels is limited by the size of the image and the spectral dispersion of the said pixel until it starts to overlap other pixel's spectrum. The cylindrical lens arrays and/or slit arrays have physical limits for its size and focusing power. Therefore, more than 20 spectral channels are difficult in that case. In Tkaczyk et al.'s case of SD-OCT system the spectral interferogram image is sliced by image mapper having several sets of group of mirrors with distinct angular positions within the group. In effect, the scheme is similar to dispersing along rows (columns) direction except that aspect ratio of the image at FPA is improved by dividing long ribbon of dispersed images into manageable lengths and placing segments side by side at FPA by means of image mapper. Complexity of image mapper, particularly with many faceted mirrors within and expected additional field of view corrector makes Tkaczyk et al.'s approach less attractive for practical use. Bodkin et al. in U.S. Pat. No. 8,233,148 shows improvement over U.S. Pat. No. 8,174,694 but falls short of teaching full potential of SIS with lenslet and/or pinhole array.

### SUMMARY

The invention disclosed utilizes dispersion along an oblique direction at least 2° away from the direction of rows or columns of spherical lens array (lenslet) and/or pinhole array (PA) to allow spectral signature of pixels to spread, without overlapping on to each other and over several times row (or column) spacing of pixel array formed for one spectral channel. This would make possible increasing number of spectral channels in many SIS systems without increase in design complexity, optics and mechanical performance requirements, and parts count over comparable prior art systems. The said parameters may even be relaxed in some instances.

In an embodiment of a SIS system the lenslet is placed at or near the input to divide the field of view into a 2D array, meaning, an array of sharply focused illumination spots of each EMR input image pixel. Each lens in the lenslet array integrates image within the said lens aperture, focuses or images to a sharp point and creates nearly illumination free region surrounding it. This effectively sets the spatial resolution of the system if other components, such as FPA, input optics or collimating-reimaging optics do not restrict the same. A reflective or absorbing PA may be placed to remove unwanted EMR either scattered or misdirected due to deficient imaging/focusing capabilities of optics. If the desired nearly illumination free regions have sufficient contrast ratio to expose the FPA, then PA may not be needed. On the other hand, if the input EMR image is sufficiently strong and the imager's spatial resolution is about same to the PA row/column spacing then PA alone may work without use of lenslet. A dispersing and reimaging optics that follows directs dispersed pixels to distinct detectors in FPA. The dispersion angle is chosen to disperse the spectrum of each pixel after lenslet and/or PA not only in the dark area near the said pixel at one wavelength but in dark areas extending many times rows (or column) spacing of pixel array at single wavelength. Long path lengths of spectral signatures of dispersed pixels in the said dark region make more spectral channels possible. The spatial image on FPA of one spectral channel would coincide with lenslet and/or PA array centers following transformation according to dispersion direction and reimaging optics. The dispersed spatial image at FPA would follow the dispersion direction in the same array format with successive spectral channel shifting one pixel in the direction of dispersion. Many spectral channels would be possible before array's spectrum overlap with oblique dispersion direction.

Dispersion in oblique direction to rows or columns directions produces final image geometry at FPA with closer to 1:1 aspect ratio. Common FPAs have rectangular shape with about equal sides in general. With dispersion in oblique direction, detectors near boundaries in a rectangular shaped FPA may not receive any EMR because of the staggering of dispersed pixels at FPA. Those detector sites would not be of any use. The percentage loss of detectors for such site though undesirable, would be small and shall not be of much concern. It will be apparent to one with ordinary skill in the art that a custom FPA can be made to optimally use the characteristics of oblique dispersion.

In other embodiments of SIS systems, lenslet directly focuses each individual input pixel on to a unique detector of the FPS. The lenslet has integral properties of oblique dispersion and focusing. These embodiments have an advantage of fewer optical components. PA may not be used in one or more of these embodiments.

It is understood that dispersive property can be obtained with a wedge shaped optical element having EMR dispersion or with a grating, blazed or un-blazed. Therefore, a dispersive wedge can be substituted for grating or vice versa in any of the embodiments illustrated. The FPA generates radiation intensity value of each pixel in the array. The values are read out at a specific time in a buffer for processing. The FPA pixel positions are re-formatted according to the system design and a data cube is stored in the memory for later usage or display in real time.

### BRIEF DESCRIPTION OF THE FIGURES

FIG. 1 illustrates a snapshot spectral imaging system with dispersing wedge oblique to lenslet array and/or pinhole array according to one embodiment.

FIG. 2A illustrates 2D array pattern of pixels produce by lenslet and/or pinhole array.

FIG. 2B illustrates spectral signature of several pixels from lenslet and/or pinhole array near FPA after oblique dispersion and reimaging.

FIG. 3A illustrates a snapshot spectral imaging system with pinhole array according to one embodiment.

FIG. 3B illustrates a snapshot spectral imaging system with lenslet according to one embodiment.

FIG. 4A shows relation of angle between dispersion direction and rows (columns) direction to the size of circular pixels and their spacing to extend spectral signature region.

FIG. 4B shows relation of angle between dispersion direction and rows (columns) direction to the size of rectangular pixels and their spacing to extend spectral signature region.

FIG. 5A illustrates lenslet with integral dispersion property with a common wedge on focusing side surface.

FIG. 5B illustrates one of the lens of lenslet with integral dispersion property with a wedge on focusing side surface when each lens in the array is identical.

FIG. 6A illustrates lenslet with integral dispersion property with etched or ruled grating on the focusing side surface.

FIG. 6B illustrates lenslet formed using self-focusing fibers.

FIG. 6C illustrates lenslet formed using square lenses.

### DETAILED DESCRIPTION

Description that follows provides detailed information of each embodiment of the invention with reference to figures listed in BRIEF DESCREPTION. It is understood that while avoiding description of generally known features for brevity, many specific details and examples are given here to provide easy understanding of the concepts but the invention may be practiced without such specific details as apparent to one of ordinary skill in the art.

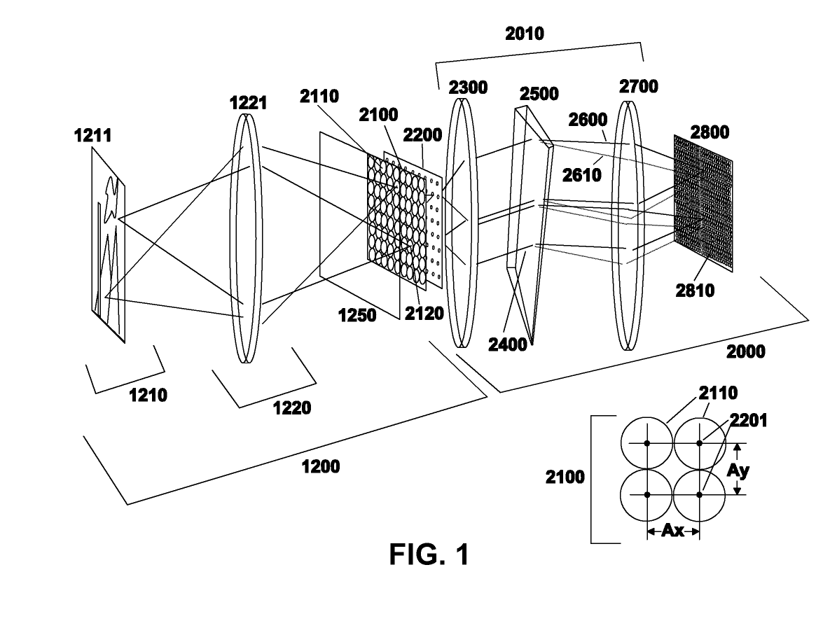

FIG. 1 shows a Snapshot Imaging Spectrometer (SIS) system 2000 that receives EMR at the input from a front imager 1200. The front imager may be a camera and/or other imaging instrument as in SHI or an interferometric image from depth encoded EMR as in SSD-OCT that forms image at the input plane 1250. Each lens 2110 in a lenslet 2100 at or near to the image plane 1250 focuses or reimages each individual pixel 2120 of the image to a smaller size near its focal position while creating large surrounding area nearly void of EMR. A pinhole array 2200 transmits main portion of EMR while blocks undesired scattered and/or misdirected EMR due to deficient optical focusing or imaging capability of lenslet 2100. Each lens 2110 in lenslet 2100 integrates EMR within its image pixel, setting spatial resolution of the system nearly equal to row/column spacing Ax/Ay of the lenslet-PA. If one or more components, such as FPA 2800, input imager 1200 or dispersing and reimaging optics 2010 limit spatial resolution then the system spatial resolution would be determined by the limiting component/s.

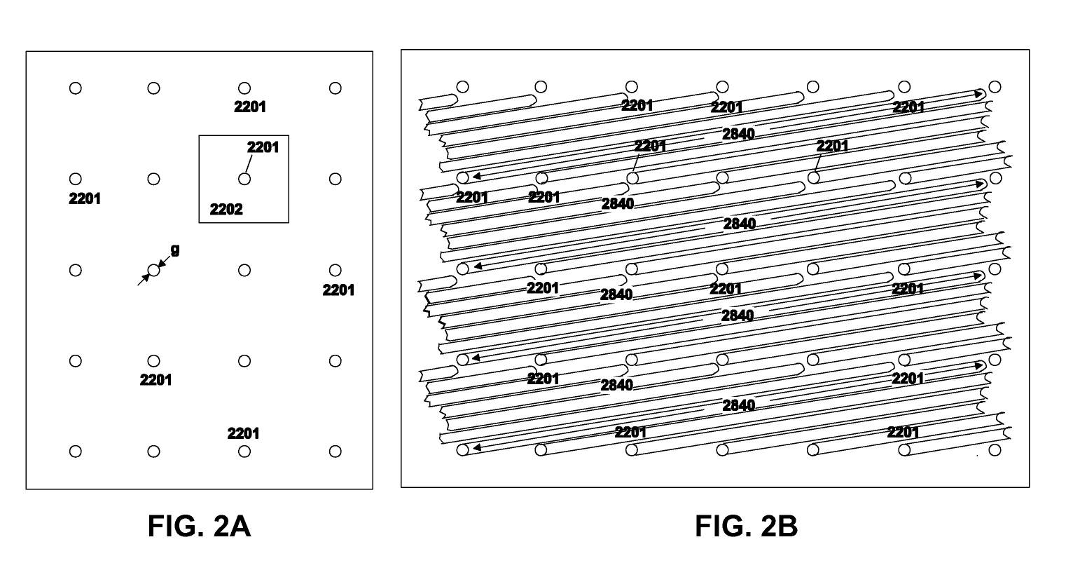

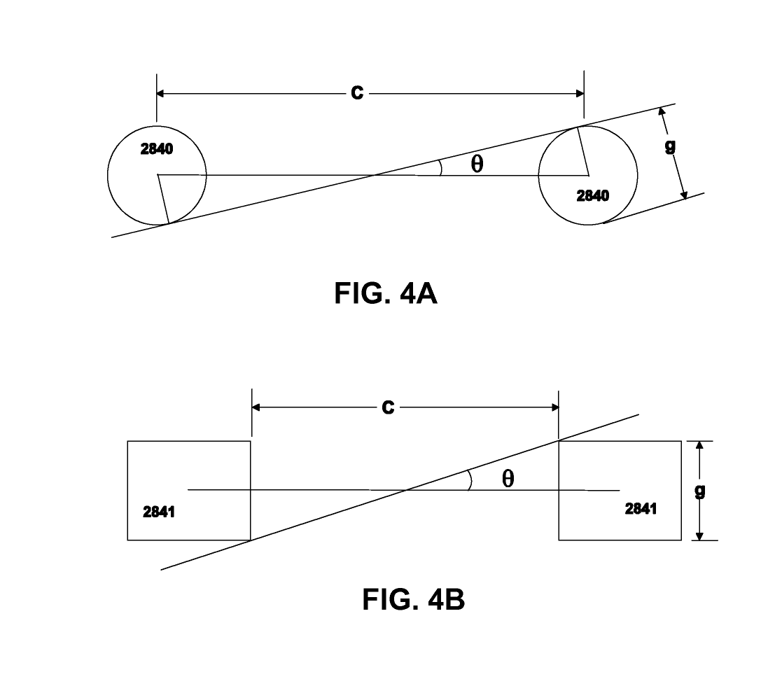

Lenses 2110 in the lenslet and focused array of pixes 2201 from lenslet and/or PA are depicted in the inset with column spacing Ax and row spacing Ay. The focused or imaged array of pixels 2201 from lenslet-PA are collimated by a collimating lens 2300 and dispersed at an oblique angle 0 from lenslet-PA rows or columns direction by a dispersing element 2500. The said element 2500 depicts wedge in both x and y direction. 0 is chosen equal or greater than 2° to obtain non-overlapping spectral signature spreading length of pixels longer than several times row (or column) spacing of a pixel array formed for one spectral channel. This is schematically shown in FIG. 2B and mathematical relation is further obtained in FIG. 4. The reimager 2700 images the dispersed pixels on individual detectors 2810 of FPA 2800 to generate signals indicative of pixel's intensity within the designated spectral channel of the received EMR. Data from FPA 2800 are commonly digitized, re-formatted, displayed as image showing spectral channels for SHI or depth for SSD-OCT as assigned colors, contour or in some other form, and stored in data cube form for further processing.

For M×N resolvable spatial field and S spectral channels at least M×N×S number of detectors would be needed within a FPA. Since an array of M×N pixels form a spatial image at one spectral channel and when shifted one detector position in oblique direction represent next spectral channel, M×N×S active detectors are needed. The obliquely dispersed pixel array has staggered rectangular shape. Therefore, a rectangular FPA would require some additional detectors lying near the edges that may not receive useful EMR. However, the fraction of such inactive detectors would be small within the FPA.

FPAs with over 50 Megapixels have become available and may be utilized for high spatial and spectral resolution SIS systems. Those FPAs may provide high resolution systems such as an example, 200 spectral channels and 500×500 spatial pixels image. Prior art embodiments would be impractical for such high resolution systems, while systems utilizing oblique dispersion and lenslet and/or PA as disclosed would be more feasible.

FIG. 2A depicts the pattern of compressed pixels 2201 produced by lenslet and/or PA. An image pixel 2120 whose size is Ax by Ay and about equal to lens 2110 size in the lenslet 2100 is focused or imaged (compressed) to size g and depicted as pixels 2201 to create nearly illumination free region 2202 surrounding each such pixel. The illumination free regions are occupied by spectral signature of dispersed pixels in the final image.

FIG. 2B illustrates the spectral signatures 2840 of pixels formed near FPA 2800 after collimating-dispersing-reimaging optics 2010 in one or more embodiments. Non-overlapping spectral signatures could have lengths several times row or column spacing as schematically depicted. The number of possible spectral channels in this arrangement would be limited to about the ratio (C/g)² where, C, equals row (or column) spacing of lens in lenslet or same for pinhole in PA and, g, equals focused or imaged spot size produced by a lens or pinhole. For C=A, g=d, and A/d=15 the number of spectral channels increases from about 30 in prior art to about 225 in embodiments of the current invention. Spectral signature lengths must be limited so as not to allow them to overlap. The dispersion strength and system spectral range would need to ensure this.

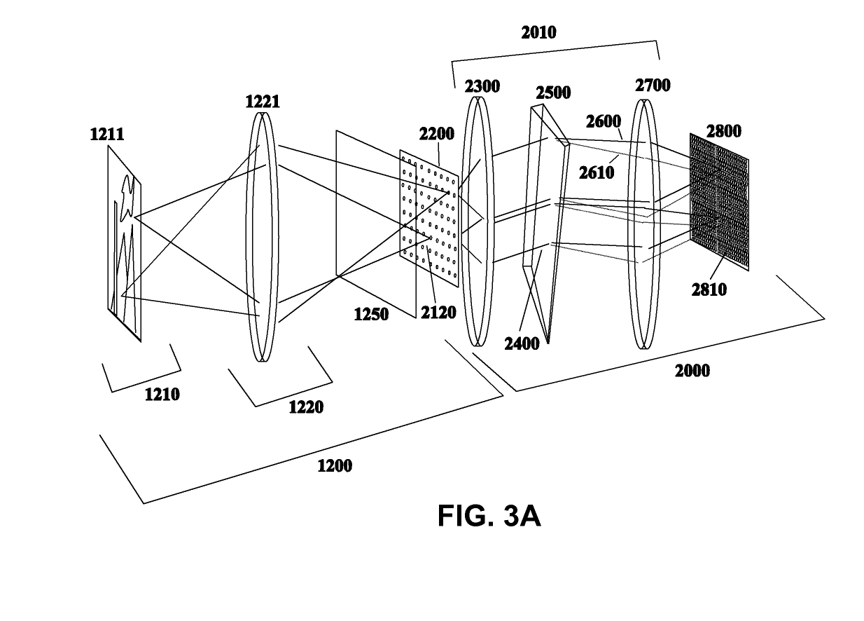

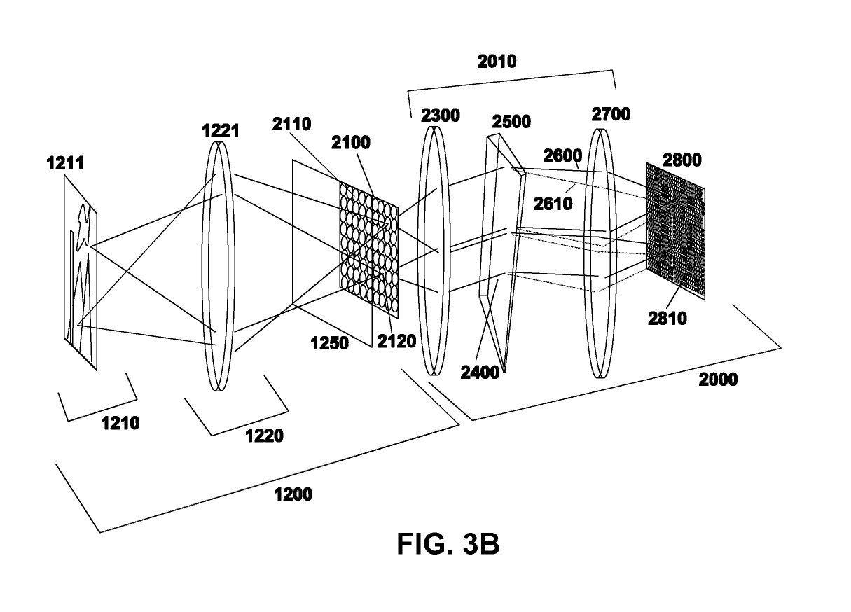

FIG. 3A illustrates a snapshot spectral imaging system with pinhole array according to one embodiment. SIS systems without lenslet may be realized for a strong intensity of input EMR at the image plane 1250. A PA 2200 may sample the input pixels intensity to create compressed pixel array 2201. The reduced EMR strength after PA still would be strong enough to produce sufficient quality data cube from FPA 2800 due to strong intensity of the input. The row and column spacing of array of PA 2200 is selected equal to the front imager 1200 spatial resolution so as to sample the integrated EMR over the pixel. Detection and signal processing is performed to generate data cube with FPA following the PA, dispersion and reimaging as in embodiment of FIG. 1.

In another embodiment in which lenslet's and front imager's optical quality is superior so that illumination in the regions 2202 is sufficiently low for FPA response; SIS systems may be built without PA 2200 in this case as shown in FIG. 3B.

FIG. 4A graphically shows mathematical relation of angle, θbetween dispersion direction and rows (columns) direction to the size of pixels and their spacing for circular pixels in accordance with the current invention. To keep a spectral signature 2840 clear of the neighboring spectral signature, we must have θ>sin⁻¹(g/C) as depicted for a circular pattern. For a rectangular pattern the relation changes to θ>tan⁻¹(g/C) with g and C depicted as in FIG. 4B.

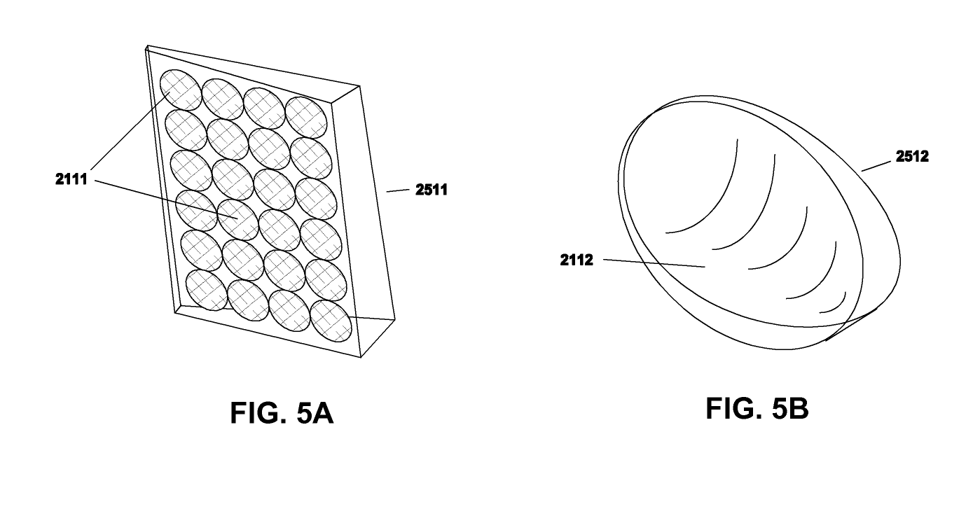

FIG. 5A illustrates an embodiment in which the dispersion property is integrated with the lenslet. A wedge 2511 of dispersive material which may or may not be same as the lens part 2111 of the lenslet 2100 is either bonded or made integral part of the lenslet on the focusing side. EMR of each image pixel passing through lens at its position is dispersed according to the invention disclosed and focused on FPA 2800 with spectral signature. Collimating-dispersive-reimageing optics 2010 is eliminated in this embodiment so that a small SIS system may be realized. Instead of a common wedge on the lenslet, individual lens in the lenslet may have dispersive wedge 2512 as illustrated in FIG. 5B.

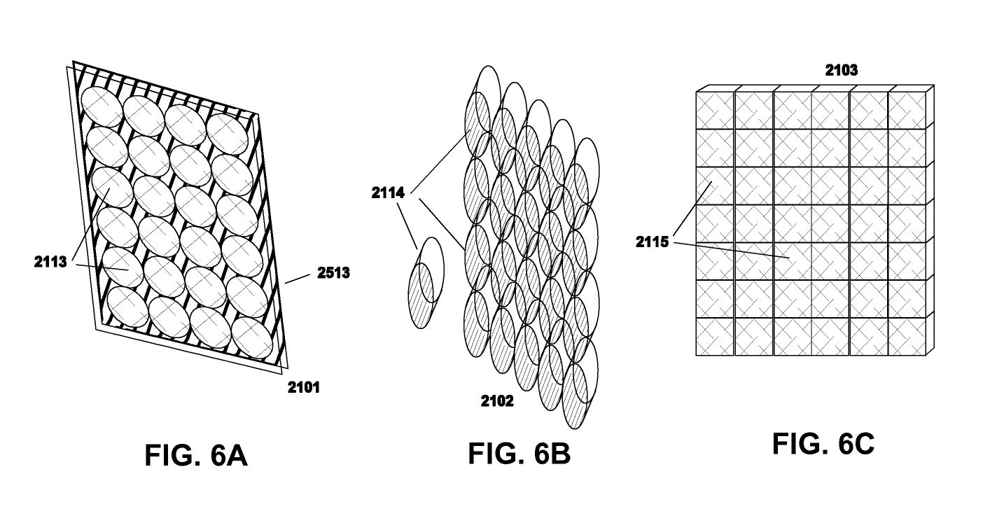

A blazed or un-blazed grating can perform dispersive function in place of optical wedge. Etching or micromachining of grooves on the focusing side of lenslet may be easier in some instances. FIG. 6A illustrates integral dispersive grating 2513 and lens elements 2113 in the lenslet for use in SIS systems according to the present invention.

A self-focusing fiber section known as “green lens” may be employed as lens in the lenslet. Green lenses provide superior focusing and imaging quality and can be fabricated in long bundle form and may be sectioned to form lenslet. A lenslet 2102 using green lenses 2114 is illustrated in FIG. 6B for use in SIS systems according to the current invention. A lenslet can be formed with circular lens elements or it can be formed with square or even rectangular lenses. FIG. 6C illustrates lenslet 2103 formed using square lenses 2115 for use in SIS systems disclosed here.

It is understood that while the invention has been described using few exemplary embodiments, those with ordinary skill in the art and with the knowledge of this disclosure may devise other methods and other embodiments to achieve the same without departing from the scope of the invention as disclosed herein. Therefore, the scope of this invention is limited by the following claims only.

What is claimed is:

1. A method for Snapshot Spectral Imaging (SIS): comprising:
receiving a range of broadband electromagnetic radiation (EMR), generated, scattered, backscattered or reflected by one or more objects or receiving the same as depth-encoded interfergram; the said EMR configured to emanate as a two dimensional image;
dividing the field of view of the said image into M×N array of pixels;
integrating EMR over a pixel area and focusing or imaging the said integrated EMR to a spot for every pixel in the array;
thereby creating M×N array of focused spots wherein each such spot is surrounded by area nearly void of EMR;
collimating, dispersing and reimaging the said M×N array of EMR on a focal plane array (FPA) and dispersion direction chosen at least 2° from rows or columns direction of the said M×N array so that;
the spectral signature of pixels do not overlap on FPA even though the spread of these signatures have length greater than two times row (or column) spacing of M×N pixel array for EMR at one spectral channel (one wavelength) on FPA;
detecting the said spectral signature of all pixels with a FPA in a single acquisition;
processing, constructing a data cube, displaying images with various characteristics and storing data.

2. A method for snapshot spectral imaging as in claim 1 in which dispersing function is combined with forming focused sots and collimating and reimaging functions are eliminated.

3. A method for snapshot spectral imaging as in claim 1 in which SIS includes snapshot hyperspectral imaging (SHI) and snapshot spectral domain coherence tomography (SSD-OCT).

4. A method for snapshot spectral imaging as in claim 2 in which SIS includes snapshot hyperspectral imaging (SHI) and snapshot spectral domain coherence tomography (SSD-OCT).

5. A snapshot spectral imaging system:
comprising:
receiving a range of broadband EMR, generated, scattered, backscattered or reflected by one or more objects or receiving the same as depth-encoded interfergram; the said EMR configured to emanate as a two dimensional image;
dividing the field of view of the said image into M×N array of pixels;
integrating EMR over a pixel area and focusing or imaging the said integrated EMR to a spot for every pixel in the array by means of a spherical lens array (lenslet) and/or pinhole array (PA);
thereby creating M×N array of focused spots wherein each such spot is surrounded by area nearly void of EMR;
collimating, dispersing and reimaging optics to image the said M×N array of EMR pixels with spreading into spectral signatures on a FPA and dispersion direction chosen at least 2° from rows or columns direction of the said M×N array so that;
the spectral signature of pixels do not overlap on FPA even though the spread of these signatures have length greater than two times row (or column) spacing of M×N pixel array for EMR at one spectral channel (one wavelength) on FPA;
detecting the said spectral signature of all pixels with a FPA in a single acquisition;
processing, constructing a data cube, displaying images with various characteristics and storing data.

6. A snapshot spectral imaging system as in claim 5 in which dispersing function is combined with forming focused sots and collimating and reimaging functions are eliminated.

7. A snapshot spectral imaging system as in claim 5 in which SIS system includes snapshot hyperspectral imaging and snapshot spectral domain coherence tomography (SSD-OCT) systems.

8. A snapshot spectral imaging system as in claim 6 in which SIS system includes snapshot hyperspectral imaging and snapshot spectral domain coherence tomography (SSD-OCT) systems.

9. A snapshot spectral imaging system as in claim 5 in which the lenslet comprises of green lenses.
